(19) United States
(12) Patent Application Publication
(10) Pub. No.: US 2005/0222285 A1
(43) Pub. Date: Oct. 6, 2005

(54) Flame retardant polyurethane products

(76) Inventors: Glenn Massengill, Smithfield, NC (US); Eduardo Lauer, Zebulon, NC (US)

Correspondence Address: MELVIN I. STOLTZ, ESQ., 51 CHERRY STREET, MILFORD, CT, 06460, US

(21) Appl. No.: 10/514,956

(22) PCT Filed: May 20, 2003
(86) PCT No.: PCT/US03/15752

§ 371 Date: Nov. 18, 2004

Related U.S. Application Data
(60) Provisional application No. 60/382,519, filed on May 22, 2002.

(51) Int. Cl. C08K 3/00

(52) U.S. Cl. 521/82

(57) ABSTRACT

By providing a polyol-based component and an isocyanate-based component, along with one or more flame retardant and/or smoke suppressant additives, in a reactive, injection molding process, rigid, polyurethane, foam products are achieved which are capable of exceeding all applicable standards for flame retardancy, while also comprising a density ranging between about 2 lbs. per cubic foot and 50 lbs. per cubic foot. In achieving a desired rigid polyurethane products of the present invention, the flame retardant and/or smoke suppressant additives may comprise one or more selected from the group consisting of organic additives, inorganic additives, halogenated additives, and non-halogenated additives. Furthermore, in the preferred embodiment, the three-dimensional rigid, polyurethane, foam products of the present invention comprises a thickness ranging between about 0.1 inches and 6 inches, a width ranging between about 0.1 inches and 96 inches, and an overall length ranging between about 0.1 inches and 288 inches.

### TECHNICAL FIELD

This invention relates to polyurethane foam compositions employed for decorative moldings, structural members, and the like, and, more particularly, to such products formed from polyurethane foam compositions which are capable of complying with Class A flame retardancy standards.

### BACKGROUND ART

The commercial decoration industry is a relatively mature industry wherein numerous products have been created to satisfy consumer demands and requirements. In particular, architectural or decorative moldings have been widely employed for centuries, in order to provide visual appealing accents or decorative effects to homes and structures. In addition, decorative moldings are also used to cover rough edges or imperfections that may have been created during the construction of the home or building.

Typically, architectural or decorative moldings are employed both indoors and outdoors as molding accents, structural members in door casings, railings, and replacement materials for wood in the furniture industry. Originally, architectural or decorative moldings were manufactured from wood. However, more recently, polystyrene, polyvinyl chloride, and gypsum have been employed for such products. Although polystyrene and polyvinyl chloride are inexpensive materials which can be produced easily and economically into suitable decorative products, these prior art products have been generally incapable of complying with Class A requirements for flame retardancy.

The only true material which is in compliance with these specifications is gypsum. However, since wood has been accepted in the industry for centuries, wood continues to be usable for such products, even though the flame retardancy standards are not met by wooden products.

In addition, wood and gypsum suffer from significant disadvantages. Since wood is a natural product, it is costly to produce due to the labor involved in harvesting, preparing and producing the product in a wide variety of different shapes. Furthermore, wood is also limited to two-dimensional products, without the aid of slow and expensive manufacturing processes.

Gypsum products are more flexible for three-dimensional shaping. However, the manufacturing processes are very laborious and expensive. Typically, forms must be poured in small sections by skilled artisans and are extremely heavy and awkward to manipulate and install. As a result, both wood and gypsum have inherent challenges that create hardships whenever these materials are used to create products for the commercial/residential decoration industry.

In order for any material, other than wood, to be acceptable for applications in the indoor/outdoor building industry as decorative moldings, structural members in door casings, railings, and replacement materials for wood in the furniture industry, the material must meet or exceed the specifications consistent with Class A flame retardancy standards as defined in ASTM E-84. In this standard, two parameters are tested, namely flame spread and smoke density.

Flame spread is the propagation of combustible flaming along the length of the material. Limiting flame spread in a material is critical to limiting the volume of the fire and heat release rates which can lead to flashover of the fire into other areas of the structure. In accordance with this standard, the flame spread rating, which is expressed as the result of a ratio, must not exceed 25.

Smoke is the number one cause of injury and death in fires. As a result, the second aspect associated with ASTM E-84 is smoke density. Large amounts of smoke replace the oxygen in the area of the fire with carbon dioxide, carbon monoxide, and other toxic gases. This causes suffocation or poisons the victims. It is critical to control the amount and type of gases generated in a fire to help save lives and property. In accordance with the accepted standard, smoke density, which is expressed as the result of a ratio, must not exceed 450.

In general, prior art attempts to meet these standards using materials other than wood or gypsum have been unsatisfactory. Typically, conventional polyurethane has severe weaknesses associated with flammability. The material is extremely combustible which promotes flame spread, high rate of heat release, and dense black smoke. The density ranges of these products also make it extremely difficult to reduce smoke generation.

Prior art polyurethane products have been created which are capable of meeting Class A flame retardancy standards. However, these products comprise low density formulations, typically less than 2 pounds per cubic foot, and have not been accepted in the commercial decoration market due to their low quality and their inability to provide an appearance which emulates a high end product and provides the look, feel, and handling characteristics associated with wood.

Therefore, it is a principal object of the present invention to provide a rigid, polyurethane, foam product which is capable of satisfying virtually every flame retardancy standard, in general, and the Class A flame retardancy standards defined in ASTM E-84, in particular.

Another object of the present invention is to provide a rigid, polyurethane, foam product having the characteristic features described above, which comprises a density ranging between about 2 lbs. per cubic foot and 50 lbs. per cubic foot.

Another object of the present invention is to provide a rigid, polyurethane, foam product having the characteristic features described above which is capable of being manufactured using a reactive, injection molding process.

Another object of the present invention is to provide a rigid, polyurethane, foam product having the characteristic features described above which is capable of being manufactured in 3-dimensional profiles having any desired size and/or shape. Another object of the present invention is to provide a rigid, polyurethane, foam product having the characteristic features described above which achieves a flame spread rating that does not exceed 25 and a smoke density rating which does not exceed 450.

Other and more specific objects will in part be obvious and will in part appear hereinafter.

### DETAILED DISCLOSURE

By employing the present invention, all of the difficulties and drawbacks found in the prior art products have been overcome and rigid polyurethane foam products have been achieved which are capable of being employed for a wide variety of products in the indoor/outdoor building industry, while also being fully compliant with Class A flame retardancy standards as defined in ASTM E-84. By employing the present invention, products such as decorative moldings, structural members in door casings, railings, and replacement materials for wood in the furniture industry are obtained.

Furthermore, the performance of the materials of the present invention is also suitable for use in installation applications, such as hot water pipes, wall and roof systems, and appliance installations due to the product's compliant performance in flammability under California Technical Bulletin 117, UL 94 HB, UL 94 HBF, UL 94 V2, and UL 94 VO. In addition, products manufactured in accordance with the present invention are also acceptable for entertainment applications, such as two-dimensional and three-dimensional sculptures, motion picture decorations, commercial play area decorations, and other applications associated with UL 1975 (100 kW).

It is also been found that products manufactured in accordance with the present invention pass the performance standards defined by Federal Motor Vehicle Safety Standard 302. As a result, products manufactured in accordance with the present invention can be used in the automotive industry for such products as head-liners, seat components, door and dashboard decorations, under-hood applications, and any other automotive application requiring compliance with this Standard.

Furthermore, it has been found that material manufactured in accordance with the present invention is acceptable for use in the commercial airline industry as molding or decorations on commercial airplanes, seat armrests, and other in-plane applications, due to the ability of the present invention to be in compliance with performance requirements defined in FAR 25.853a.

In accordance with the present invention, the desired components or products are formed from rigid polyurethane foam composites having a density ranging between about 2 pounds per cubic foot and 50 pounds per cubic foot. In addition, these products are all capable of meeting or exceeding the Class A flame retardancy standards as defined by ASTM E-84.

Furthermore, products manufactured in accordance with the present invention also meet Class A Specifications, a standard most other polyurethane products manufactured in the United States are incapable of meeting. These accomplishments are achieved in the present invention by incorporating aggressive flame retardants and unique combinations of smoke suppressants into the reactive injection molded polyurethane process.

By employing the present invention, products are produced which are flame retardant and exceed Class A specifications. In addition, products manufactured in accordance with the present invention are also capable of being manufactured as three-dimensional products, light-weight and easily installable decorations, while also providing substantially lower cost, economical production capabilities.

In accordance with the present invention, reactive, injection molded, rigid polyurethane products are produced which exceed the required specifications for Class A flame retardant material as defined by ASTM E-84 (25 flame spread, 450 smoke density). In the preferred embodiment, the rigid polyurethane products comprise a density ranging between about 2 pounds per cubic foot and 50 pounds per cubic foot. It has also been found that the polyurethane products of the present invention may comprise densities ranging between about 7 pounds per cubic foot and 24 pounds per cubic foot, with densities ranging between about 9 pounds per cubic foot and 20 pounds per cubic foot being optimal. In addition, the rigid polyurethane products manufactured in accordance with the present invention are enhanced by incorporating organic and/or inorganic flame retardants and smoke suppressants.

In the present invention, the reactive system comprises two principal ingredients, namely an isocyanate based component and a polyol-based component. Preferably, the isocyanate based component comprises at least one selected from the group consisting of methyl-di-isocyanates, di-isocyanurates, poly-methyl-di-isocyanates, poly-di-isocyanurates, and isocyanates. In addition, the polyol-based component comprises at least one selected from the group consisting of polyesters, polyethers, and polyols. As detailed below, these materials are generally intermixed at various proportions to create specifically desired foam properties.

In order to enhance the reactive, injection molded, rigid polyurethane materials with the desired, unique, flame retardant properties, one or more organic and/or inorganic flame retardants and/or smoke retardant suppressants are incorporated into the composition, along with one or more smoke suppressants. Preferably, the flame retardants and smoke suppressants comprise one or more selected from the group consisting of magnesium hydroxide, talc, quartz, silica, tin oxide, aluminum tri-hydrate, molybdenum oxate, zinc stanate, and boron hydride. Although one or more of these compounds have been found to be highly effective in enhancing the resulting product by substantially reducing flame spread and smoke density, the use of aluminum tri-hydrate and zinc stanate are preferred.

It has also been discovered that in employing the organic and/or inorganic flame retardants and/or smoke suppressants compounds detailed above, the desired flame retardants and/or smoke suppressants may be metered into the composition of the present invention as an additional stream during the intermixing of the isocyanate based components and the polyol based components. In addition, if desired, the flame retardants and/or smoke suppressants may be premixed into one or both of the main reactive materials.

Regardless of the process employed for intermixing the desired flame retardants and/or smoke suppressants, the compositions employed preferably comprise a sufficient quantity of the desired compounds to range between about 0% by weight and 95% by weight, based upon the weight of the entire composition. Although the foregoing percentages have been found to be efficacious, it has also been found that the flame retardants and/or smoke suppressant compositions preferably range between about 0% by weight and 75% by weight, based upon the weight of the entire composition, with a range of between about 0% by weight and 65% by weight, based upon the weight of the entire composition, being optimum.

In addition, it has also been found that halogenated or non-halogenated compounds selected from the group consisting of decabromadiphenyl oxide, octabromadiphenyl oxide, hexabromadiphenyle oxide, small-chained non-cyclic brominated compounds, chlorinated parrafins, cyclic and non-cyclic chlorinated compounds, boron containing materials, phosphate containing materials, and any other organic materials which may be used to retard flame spread or smoke generation may be employed to retard flame spread or smoke generation. Preferably, these compounds are employed in quantities ranging between about 0% by weight and 95% by weight, based upon the weight of the entire composition. Furthermore, these compounds may be employed in the composition as flame retardants and/or smoke suppressants either by direct metering into the composition or pre-mixing these ingredients into one or both of the main reactive streams.

Although the foregoing ranges have been found to be efficacious, it has been found that the halogenated and non-halogenated compounds detailed above are preferably employed in quantities ranging between about 0% by weight and 50% by weight, based upon the weight of the entire composition. In addition, quantities ranging between about 0% by weight and 25% by weight, based upon the weight of the desired composition, have been found to be optimum.

In producing reactive, injection molded, rigid polyurethane products in accordance with the present invention, it has been found that the isocyanate based component preferably comprises between about 25 parts and 75 parts of the overall composition. In addition, the polyol-based component preferably comprises between about 50 and 150 parts of the overall composition.

In addition, in formulating the preferred polyurethane products in accordance with the present invention, the isocyanate based components preferably comprise between about 5% by weight and 95% by weight, based upon the weight of the entire composition. In addition, it has been found that quantities of these components preferably range between about 25% by weight and 75% by weight, based upon the weight of the entire composition, with a range of between about 45% by weight and 65% by weight, based upon the weight of the entire composition, being optimum.

Furthermore, the preferred polyurethane products of the present invention comprise between about 5% by weight and 95% by weight, based upon the weight of the entire composition, of the polyol based component. In addition, quantities of the polyol based component preferably range between about 25% by weight and 75% by weight, based upon the weight of the entire composition, with quantities ranging between about 45% by weight and 65% by weight, based upon the weight of the entire composition, being optimum.

In the most preferred formulations, aluminum tri-hydrate and zinc stanate are employed for the flame retardants and smoke suppressants. In this regard, the composition incorporates these components in quantities ranging between about 0% and 50% by weight, based upon the weight of the entire component, and more preferably between about 0% and 25% by weight, based upon the weight of the entire composition.

In preparing the preferred formulation of the present invention, blowing agents are preferably employed in the formation process. Although any blowing agents capable of generating a foam product in the desired density ranges can be employed, provided the blowing agent meets fire specifications of Class A products, it has been found that the blowing agent preferably comprises one or more selected from the group consisting of water, carbon dioxide, pentane, isopentane, butane, isobutene, hexane, heptane, HCFC 141b, HCFC 134a, and HCFC 245fa.

In addition, it has been found that the quantity of blowing agent incorporated into the composition ranges between about 0% and 95% by weight, based upon the weight of the entire composition, with between about 0% and 35% by weight, based upon the weight of the entire composition, being preferred and between about 0% by weight and 25% by weight, based upon the weight of the entire composition, being optimum. Furthermore, the blowing agent can be metered as a separate stream into the reactive ingredients or, if desired, mixed into one or both of the main reactive streams.

In forming the desired reactive, injection molded, rigid polyurethane products in accordance with the present invention, it has been found that the product preferably comprises a thickness ranging between about 0.1 inches and 6 inches. In addition, a thickness ranging between about 0.1 inches to 3 inches is more preferred, with a thickness ranging between about 0.1 inches and 1.25 inches been optimum.

Furthermore, the rigid polyurethane products also preferably comprise a width ranging between about 0.1 inches and 96 inches. In addition, a width ranging between about 0.1 inches and 48 inches is more preferred, while a width ranging between about 0.1 inches and 30 inches is optimum. Finally, the overall length of product produced in accordance with the present invention preferably range between about 0.1 inches and 288 inches. In addition, a length ranging between about 0.1 inches and 192 inches is preferred, while a length ranging between about 0.1 inches and 144 inches is optimal.

It has also been found that the processing parameters employed in manufacturing the polyurethane foam materials of the present invention can be optimized to accommodate different densities. This process optimization was accomplished by empirically modifying the raw material storage temperatures, modifying the line feeding temperatures, modifying the injection head temperatures, and modifying the mold temperatures to change the viscosity and reaction times of the components. The parameters that were studied included mold filling tendency, mixing consistency, cream time, rise time, “free rise” density and tact time.

Mold filling tendency is defined as the ability of the materials to complete the detail present within the mold during the pouring and curing process. The viscosity of the blended material during injection and rise are critical to produce a detailed continuous part.

Mixing consistency pertains to the ability of the components to be combined in a consistent, single-phase system. This is a complex issue due to the addition of solids into the system and the difference in the viscosities between the isocyanate and the polyol streams. In order to achieve the desired results, the powders are metered into the polyol liquid by weight either manually or be the use of mechanical feeding systems. By conditioning the polyol liquid to elevated temperatures, the solubility of the powders into the liquid is greatly improved. It has also been found that the blade design and speed also play major factors in the production of a consistent premix polyol component.

Once the powders are thoroughly mixed, the components are loaded into the storage/metering tank where the temperature is monitored and optimized. This composition must be continually agitated to prevent settling.

The isocyanate is loaded into another storage/metering tank where the temperature is monitored and optimized. The temperatures should be controlled to achieve as similar as possible viscosities between the two components. During trials, it has been found that storage temperature for both components range between about 50° F. to 140° F. However, the materials started to show signs of degradation about 100° F. The materials' viscosities proved to be most similar around 90° F. which proved to be the target storage temperature for both components.

In addition, humidity is kept to an absolute minimum because of the reactivity of the isocyanate with atmospheric moisture. This can be achieved with the addition of an inert gas blanket inside the storage container.

Also, mixing consistency is greatly influenced by the dynamic mixing that occurs when the materials are mixed. Low pressure machines provide the best opportunity to optimize this process since they are routinely outfitted with dynamic mixing elements. The raw material streams are fed directly into a mixing chamber where specialty designed mixing elements rigorously whip the materials into a consistent soup. In high pressure machines, it is imperative to match the viscosities of the inlet streams, the velocities of the inlet streams, and orifice sizes of the inlet streams to achieve a consistent blend because the mixing is dependent on the dynamic interchange of the materials themselves in the mixing chamber.

The “cream time” is the next critical parameter to be optimized in the system. Because we have several processes in which this material can be run, it is necessary to match the reaction times of the materials to our manufacturing process. The “cream time” is defined as the time at which the materials start to react to begin cross-linking once they are introduced to each other. In our processes, these times must vary from as little as 1 second to as much as 240 seconds. However, the “cream time” preferably ranges between about 1 second and 120 seconds, with a “cream time” ranging between about 1 second and 60 seconds being optimal. These changes can once again be influenced by temperature. The higher the temperature, the shorter the “cream time”. Conversely, the lower the temperature, the longer the “cream time”. The “cream time” may also be considerably influenced by the catalyst concentrations.

Catalysts are introduced to lower the activation energies to help begin reactions. The levels of these catalysts are controlled by the raw material supplier depending on the need to begin the reactions. It is rather easy to control the rate of these reactions with the adjustment of these catalysts levels.

It is important to maintain the longest “cream time” that is economically feasible to ensure the material has time to flow into the crevices of the mold. The viscosity before cream is the lowest that exists in the mixed system.

The next parameter that is important is the “rise time” of the material. The “rise time” is defined as time from when the material creams until it ceases to grow in volume. The “rise time” is dependent on the degree of cross-linking in the system and the amount of blowing agent that is present. The degree of cross-linking is important because it determines viscosity of the fluid during rise (expansion). Therefore, it also lends great value to filling detailed moldings. The degree of cross-linking also provides melt strength to the material to allow for expansion without rupturing or cracking. Typically, the “rise time” ranges between about 5 seconds and 900 seconds. However, a “rise time” ranging between about 15 seconds and 600 seconds is preferred, while a “rise time” ranging between about 30 seconds and 420 seconds is optimum.

If the “rise time” is not long enough, the material will rise faster than cross-linking is occurring, thereby causing cracks and ruptures in the foam. The amount of blowing agent present is also important to control the “rise time”. The reactive injection molding process is an exothermic process which generates its own heat to volatilize the blowing agent. The blowing agent continues to volatilize until it is completely consumed. The volatilized material produces pressure within the crosslinked web which allows the polyurethane to expand and produce foam.

The amount of blowing agent determines the “free rise” density of the material. The “free rise” density is defined as the density achieved with full volatilization of the blowing agent within the polyurethane foam without any restrictions on the volumetric expansion. When developing a mold, a good rule of thumb is to have the “free rise” density of the material to be roughly half of the completed part density. This will allow for pressurized expansion within the mold and complete filling of the part.

The final parameter that is critical for the consideration of a polyurethane part is “tact time”. “Tact time” is defined as the point at which the polyurethane material is capable of being touched by an outside agent without adhering or stringing away from the rest of the material body. The actual chemical phenomenon is described as the point at which the rise is complete and the cross-linking reactions are finished. The material is rigid and the surface texture is hard.

Typically, the tact time ranges between about 5 seconds and 90 seconds. However, a tact time ranging between about 15 seconds and 600 seconds is preferred, with a tact time ranging between about 30 seconds and 420 seconds being optimum.

The processes described above can be implemented in three methods for manufacture: open-pour reactive injection molding process, continuous reactive injection molding process, and closed-mold reactive injection molding process. Each of these processes is capable of utilizing mold tooling constructed for solid metals, porous metals, wood, molded thermosets, thermoplastics, silicones, or any other material suitable for the processing temperatures, pressures, and release properties required to achieve a good part.

In addition, each of the processes may be implemented with the use of all conventional mold release techniques, such as “permanently” coated molds, commercial mold releases, organic waxes, pressurized air, impregnated removal tools, in-mold films (releasable or investment cast), or any other method of mold release to allow a clean departure from the molding material. Each of the processes may also be processed with all conventional metering equipment, including high pressure and low pressure machinery, available today for processing two-part reactive injection molding materials.

Other possibilities include reducing/removing the amount powder from the polyol component and including part or all of it into the isocyanate stream or feeding it in as an additional stream. The mixing may be sufficient in the dynamic mixing head to accommodate the dispersion without a premixing step in the process. The blowing agents may also be introduced by an additional stream to control the amount of foaming.

Once products were produced employing the present invention, it became evident that the materials have all of the requisite properties which are necessary for use in the indoor-outdoor building industry as decorative moldings, structural members in door casings, railing, and replacement materials for wood in the furniture industry. Furthermore, the performance of these materials made the products suitable for use in insulation applications such as hot water pipes, wall and roof systems, and appliance insulations, due to its compliant performance in flammability to UL 94 HB, UL 94 HBF, UL 94 V2, and UL 94 VO. Also, the material performed acceptable for entertainment applications such as two dimensional and three dimensional sculptures, motion picture decorations, commercial play area decorations, and all other applications associated with UL 1975 (100 kW). Finally, the material is acceptable for use in the airline industry as molding decoration on commercial airlines, seat armrests, and other in-plane applications due to its passing performance in FAR 25.853a.

The finished polyurethane foamed products of the present invention typically comprise an average cell size ranging between about 0.001 and 10 mm. In this regard, however, an average cell size ranging between about 0.001 mm and 3 mm is preferred, with an average cell size ranging between about 0.001 mm and 1 mm being optimal.

Furthermore, the foamed polyurethane product may be coated with a flame retardant coating which can consist of a single component or a mixture of such materials as halogenated flame retardant compounds, non-halogenated flame retardant compounds, intumescent flame retardant compounds, inorganic materials, or any other type of material suitable to maintain the Class A specifications fire rating for the application thickness of the entire composite. In addition, the flame retardant coating may be applied to the foamed composition in a thickness from 0 mils to 120 mils to achieve the Class A specifications fire rating for the application thickness of the entire composition.

### BEST MODE FOR CARRYING OUT THE INVENTION

In order to demonstrate the efficacy of the present invention, numerous foamed polyurethane products were constructed from various formulations of the present invention and manufactured using the processes detailed above. Each of the resulting foamed polyurethane products were tested for comparative purposes in order to establish the ability of each formulation to meet the flame retardant standards defined by Class A of ASTM E-84. The results of this testing program are provided below.

Table I provides the results achieved for the flame spread and smoke density, in accordance with the standards defined by Class A specification of ASTM E-84, for each of the different examples of products manufactured and tested in the first test program. In each product tested, polyol and isocyanate were employed as the main reactants, with each of these compound streams incorporating 60% by weight, based upon the weight of each stream, of aluminum tri-hydrate. In addition, the polyol reactants in Examples 1 and 2 also incorporated a bromated organic flame retardant, while the remaining Examples employed an off-the-shelf flame retardant.

TABLE I

| | Density | | |
|---|---|---|---|
| Example | (LBS/FT³⁾ | FLAME SPREAD | SMOKE DENSITY |
| 1 | 24 | 40 | 884 |
| 2 | 18 | 43 | 896 |
| 3 | 15 | 32 | 338 |
| 4 | 24 | 29 | 461 |
| 5 | 24 | 30 | 591 |

In order to improve the test performance results and attain a product capable of fully satisfying the flame retardancy requirements of a Class A product as defined by ASTM E-84, the formulation of the foamed polyurethane product defined by Example 3 was employed as a control with a wide variety of coatings being applied thereto. In this regard, flame-retardant, organic/inorganic reactive intumescent coatings were employed, along with flame-retardant, epoxy-based, coatings and flame-retardant latex coatings.

The test data achieved from this program is detailed in Table II. As is evident from these results, the reactive intumescent coatings proved to be the most effective as a fire blocked and smoke suppressor. In addition, the coatings were evaluated using the after-flame time of UL 94 HB as a qualifier.

TABLE II

| | | | | Average |
|---|---|---|---|---|
| | | | After- | After- |
| | | | Flame | Flame |
| | Description of | | Time | Time |
| Coating | Coating | Event | (Sec) | (sec) |
| Blank | No Coating | 1 | 31 | |
| Blank | No Coating | 2 | 34 | |
| Blank | No Coating | 3 | 18 | 27.6 |
| Control | White Solvent-Based | 1 | 35 | |
| | Barrier Coat | | | |
| Control | White Solvent-Based | 2 | 50 | |
| | Barrier Coat | | | |
| Control | White Solvent-Based | 3 | 55 | 46.7 |
| | Barrier Coat | | | |
| 10—10 Flame Control | Intumescent Paint | 1 | 15 | |
| 10—10 Flame Control | Intumescent Paint | 2 | 5 | |
| 10—10 Flame Control | Intumescent Paint | 3 | 3 | 7.7 |
| FX 100 Coating | No Barrier Paint | 1 | 25 | |
| FX 100 Coating | No Barrier Paint | 2 | 4 | |
| FX 100 Coating | No Barrier Paint | 3 | 10 | 13 |
| FX 100 Coating | White Solvent-Based | 1 | 10 | |
| | Barrier Coat | | | |
| FX 100 Coating | White Solvent-Based | 2 | 13 | |
| | Barrier Coat | | | |
| FX 100 Coating | White Solvent-Based | 3 | 5 | 9.3 |
| | Barrier Coat | | | |
| 40—40 Flame Control | Intumescent Paint | 1 | 23 | |
| 40—40 Flame Control | Intumescent Paint | 2 | 23 | |
| 40—40 Flame Control | Intumescent Paint | 3 | 40 | 34.3 |

In the final group of tests which were conducted in order to clearly and unequivocally demonstrate the ability of the present invention to comply completely with the standards defined and ASTM E-84, foam polyurethane products were constructed with a one inch thickness, using the formulation and processes detailed above. This product was constructed with a density of 12 pounds per cubic foot and was coated with 10⁻¹⁰ flame control intumescent paint.

Three separate and independent samples were prepared and tested, as required by ASTM E-84, wherein the Standard requires three consecutive test results to be performed with the average of all three tests resulting in a flame spread of 25 or less and a smoke density of 450 or less. As detailed and Table III, the results of these three tests are shown.

TABLE III

| FLAME SPREAD | SMOKE DENSITY |
|---|---|
| 12.8 (15) | 65.383 (65) |
| 15.79 (15) | 58.065 (60) |
| 16.93 (15) | 151.5 (150)* |
| 15.17 (15) Average | 91.6 (150)** Average |

*Since the sample is an outlier, the test method requires reporting the average as the high value.
**The test method requires that all of the values be rounded to the nearest 5 for averaging.

It will thus be seen that the object set forth above, among those made apparent from the preceding description, are efficiently obtained and since certain changes may be made in carrying out the above process and as a composition set forth without departing from the scope of the invention, it is intended that all matter contained in the above description shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Particularly it is to be understood that in said claims, ingredients or compounds recited in the singular are intended to include compatible mixtures of such ingredients wherever this sense permits.

1. A rigid, polyurethane, foam product constructed for satisfying Class A flame retardancy standards and comprising:
A. a density ranging between about 2 lbs. per cubic foot and 50 lbs. per cubic foot;
B. between about 5% and 95% by weight based upon the weight of the entire composition of a polyol-based component; and
C. between about 5% and 95% by weight based upon the weight of the entire composition of an isocyanate-based component;
whereby a rigid polyurethane foam product is obtained which is capable of being employed in a wide variety of configurations and used in a wide variety of alternate applications and industries.

2. The rigid, polyurethane, foam product defined claim 1, wherein said density ranges between about 7 lbs. per cubic foot and 24 lbs. per cubic foot.

3. The rigid, polyurethane, foam product defined claim 1, wherein said density ranges between about 9 lbs. per cubic foot and 20 lbs. per cubic foot.

4. The rigid, polyurethane, foam product defined in claim 1, and further comprising at least one flame retardant and/or smoke suppressant additive incorporated therein.

5. The rigid, polyurethane, foam product defined in claim 4, wherein said flame retardant and/or smoke suppressant is further defined as comprising one selected from the group consisting of organic and inorganic additives.

6. The rigid, polyurethane foam product defined in claim 5, wherein said organic and/or inorganic additives are further defined as comprising at least one selected from the group consisting of aluminum trihydrate, magnesium hydroxide, talc, antimony trioxide, quartz silica, molybdenum oxate, tin oxide, zinc stanate, or any other materials that prohibits the generation of flame spread or smoke density, and act as flame retardants, smoke suppressants, reactive synergists, and/or catalysts.

7. The rigid, polyurethane foam product defined in claim 6, wherein said inorganic and/or organic additive is further defined as being contained in at least one selected from the group consisting of the polyol-based component and the isocyanate-based component

8. The rigid, polyurethane, foam product defined in claim 6, and further comprising at least one blowing agent selected from the group consisting of water, CO², pentane, isopentane, butane, isobutene, hexane, heptane, HCFC 141b, HCFC 134a, HCFC 245fa, or any other blowing agent capable of generating a foamed product in the appropriate density range.

9. The rigid, polyurethane foam product defined in claim 8, wherein the blowing agent is further defined as being contained in at least one selected from the group consisting of the polyol-based component and the isocyanate-based component.

10. The rigid, polyurethane, foam product defined in claim 4, wherein said isocyanate-based component is further defined as comprising at least one selected from the group consisting of methyl-di-isocyanates, di-isocyanurates, polymethyl-di-isocyanates, poly-di-isocyanurates, and isocyanates.

11. The rigid, polyurethane, foam product defined in claim 10, wherein said polyol-based component is further defined as comprising at least one selected from the group consisting of polyesters, polyethers, and polyols.

12. The rigid, polyurethane, foam product defined in claim 11, wherein said flame retardant and/or smoke suppressant additive is further defined as comprising at least one selected from the group consisting of magnesium hydroxide, talc, quarter, silica, tin oxide, aluminum tri-hydrate, molybdenum oxate, zinc stanate, and boron hydride.

13. The rigid, polyurethane, foam product defined in claim 12, wherein said flame retardant and/or smoke suppressant additive is further defined as comprising at least one selected from the group consisting of aluminum trihydrate and zinc stanate.

14. The rigid, polyurethane, foam product defined in claim 11, wherein said flame retardant and/or smoke suppressant additive is further defined as comprising at least one selected from the group consisting of halogenated compounds and non-halogenated compounds.

15. The rigid, polyurethane, foam product defined in claim 10, wherein said halogenated and/or non-halogenated flame retardant and/or smoke suppressant additive is further defined as comprising at least one selected from the group consisting of decabromadiphenyl oxide, octabromadiphenyl oxide, hexabromadiphenyle oxide, small-chained non-cyclic brominated compounds, chlorinated parrafins, cyclic and non-cyclic chlorinated compounds, boron containing materials, phosphate containing materials, and any other organic materials which may be used to retard flame spread or smoke generation.

16. The rigid, polyurethane, foam product defined in claim 15, wherein said halogenated and/or non-halogenated flame retardant and/or smoke suppressant additive is further defined as being contained in at least one selected from the group consisting of the polyol-based component and the isocyanate-based component.

17. The rigid, polyurethane, foam product defined in claim 1, and further comprising between about 25% and 75% by weight based upon the weight of the entire composition of the isocyanate-based component and between about 25% and 75% by weight based upon the weight of the entire composition of the polyol-based component.

18. The rigid, polyurethane, foam product defined in claim 1, and further comprising between about 45% and 65% by weight based upon the weight of the entire composition of the isocyanate-based component and between about 45% and 65% by weight based upon the weight of the entire composition of the polyol-based component.

19. The rigid, polyurethane, foam product defined in claim 1, wherein said product comprises a thickness ranging between about 0.1 and 6 inches, a width ranging between about 0.1 and 96 inches, and a length ranging between about 0.1 and 288 inches.

20. The rigid, polyurethane foam product defined in claim 19, wherein said product is further defined as comprising a thickness ranging between about 0.1 and 3 inches, a width ranging between about 0.1 and 48 inches, and a length ranging between about 0.1 and 192 inches.

21. The rigid, polyurethane foam product defined in claim 19, wherein said product comprises a cell size ranging between about 0.001 mm. and 10 mm.

22. The rigid, polyurethane foam product defined in claim 22, wherein said product is coated with a flame retardant coating comprising one selected from the group consisting of halogenated flame retardant compounds, non-halogenated flame retardant compounds, intumescent flame retardant compounds, and inorganic materials.

23. The rigid, polyurethane foam product defined in claim 22, wherein said coating is further defined as having a thickness ranging between about 0 and 0.120 inches.

24. The rigid, polyurethane foam product defined in claim 1, wherein said product is constructed to be fully compliant with at least one flame retardancy standard selected from the group consisting of ASTM E-84, UL 94 VO, UL 1975, FMV SS 302, California Technical Bulletin 117, and FAR 25,853.a.

25. A rigid, polyurethane, foam product constructed for satisfying Class A flame retardancy standards and comprising:
A. a density ranging between about 2 lbs. per cubic foot and 50 lbs. per cubic foot;
B. between about 5% and 95% by weight based upon the weight of the entire composition of a polyol-based component comprising at least one selected from the group consisting of polyesters, polyethers and polyols;
C. between about 5% and 95% by weight based upon the weight of the entire composition of an isocyanate-based component comprising at least one selected from the group consisting of methyl-di-isocyanates, di-isocyanurates, poly-methyl-di-isocyanates, poly-di-isocyanurates, and isocyanates;
D. at least one flame retardant and/or smoke suppressant additive incorporated therein and comprising at least one selected from the group consisting of magnesium hydroxide, talc, quarter, silica, tin oxide, aluminum tri-hydrate, molybdenum oxate, zinc stanate, and boron hydride;
E. a thickness ranging between about 0.1 and 6 inches, a width ranging between about 0.1 and 96 inches, and a length ranging between about 0.1 and 288 inches; and
F. a cell size ranging between about 0.001 mm and 10 mm. whereby a rigid polyurethane foam product is obtained which is capable of being employed in a wide variety of configurations and used in a wide variety of alternate applications and industries.

26. A reactive, injection molding method for producing a rigid polyurethane, foam product constructed for satisfying Class A flame retardancy standards and comprising a density ranging between about 2 lbs. per cubic foot and 50 lbs. per cubic foot, between about 5% and 95% by weight based upon the weight of the entire composition of a polyol-based component and between about 5% and 95% by weight based upon the weight of the entire composition of an isocyanate-based component, and said method of production comprises one selected from the group consisting of open-pour reactive injection molding, continuous reactive injection molding, and closed-mold reactive injection molding.

27. A method for producing a rigid, polyurethane, foam product comprising the steps of:
A. thoroughly mixing a polyol-based component in a first mixing vessel;
B. thoroughly mixing an isocyanate-based component in a second mixing vessel;
C. loading the contents of the first mixing into a first storage/metering tank and continuously agitating the contents thereof;
D. loading the contents of the second mixing vessel into a second storage/metering tank and continuously agitating the contents thereof;
E. controlling the temperature of the contents in the first and second metering tanks to range between about 50° F. and 140° F.;
F. delivering a stream of the polyol-based component into a mixing chamber;
G. delivering a stream of the isocyanate-based component into the mixing chamber;
H. balancing the polyol-based component to comprise a ratio ranging between about 50 and 150 parts of the overall composition and the isocyanate-based component to comprise a ratio of between about 25 parts and 75 parts of the overall composition;
I. rigorously mixing the contents of the mixing chamber into a substantially uniform composition; and
J. delivering the intermixed composition to a desired reactive, injection molding equipment for forming the desired, rigid, polyurethane product.

28. The method defined in claim 27, comprising the additional step of:
K. Adding at least one flame retardant and/or smoke suppressant additive to the formulation.

29. The method defined in claim 28, wherein the flame retardant and/or smoke suppressant additive comprises one or more selected from the group consisting of organic additives, inorganic additives, halogenated additives, and non-halogenated additives.

30. The method defined in claim 29, wherein said additive is further defined as being added to the formulation by employing at least one process selected from the group consisting of metering each additive into the mixing chamber as a separate stream, adding each additive to the polyol-based mixing vessel, and adding the additive to the isocyanate-based mixing vessel.
